(19) United States
(12) Patent Application Publication
(10) Pub. No.: US 2022/0106914 A1
(43) Pub. Date: Apr. 7, 2022

(54) METHOD FOR STARTING A GAS TURBINE IN A COMBINED CYCLE POWER PLANT

(71) Applicant: Siemens Energy Global GmbH & Co. KG, Munich, Bayern (DE)

(72) Inventors: Stefan Becker, Adelsdorf (DE); Matthias Nickl, Erlangen (DE); Kai Voit, Lützelbach (DE); Johannes Walzik, Erlangen (DE)

(73) Assignee: Siemens Energy Global GmbH & Co. KG, Munich, Bayern (DE)

(21) Appl. No.: 17/261,677

(22) PCT Filed: Jul. 9, 2019
(86) PCT No.: PCT/EP2019/068367

§ 371 Date: Jan. 20, 2021

(30) Foreign Application Priority Data
Aug. 9, 2018 (DE) 10 2018 213 422.7

(51) Int. Cl. F02C 9/20; F01K 23/10; F01D 17/08; F01D 19/02

(52) U.S. Cl. CPC F02C 9/20; F01K 23/101; F01D 17/085; F05D 2270/303; F05D 2270/0831; F05D 2270/082; F05D 2270/112; F01D 19/02

(57) ABSTRACT

A method for starting and stopping a gas turbine in a combined cycle power plant, wherein the gas turbine includes a compressor having adjustable guide vanes and the gas turbine power can also be controlled by opening the guide vanes. When the gas turbine is started, it is driven up to a base load or up to an emission-compliant load point, and the guide vanes are opened before the base load or the emission-compliant load point is reached.

### CROSS REFERENCE TO RELATED APPLICATIONS

This application is the US National Stage of International Application No. PCT/EP2019/068367 filed 9 Jul. 2019, and claims the benefit thereof. The International Application claims the benefit of German Application No. DE 10 2018 213 422.7 filed 9 Aug. 2018. All of the applications are incorporated by reference herein in their entirety.

### FIELD OF INVENTION

The invention relates to a method for starting up, but also for shutting down, a gas turbine in a combined cycle power plant. The invention relates in particular to a guide-vane adjustment mode of operation for gas turbines.

### BACKGROUND OF INVENTION

Typically, gas turbines in combined cycle power plants are run up to a maximum value with closed guide vanes in the compressor. This has the advantage that the combustion in the gas turbine is stable and the emissions lie within a specification-compliant range relatively quickly. Only after attainment of the base load or after attainment of an emission-compliant load point are the guide vanes opened, in order to increase the mass flow through the gas turbine and thereby to increase the power too.

However, for combined cycle power plants, higher and higher gas turbine exhaust-gas temperatures permit only a limited capacity for quick starting of the whole plant. In particular, the heat recovery steam generator is subjected to considerable thermal stress, which leads to relatively pronounced, premature material fatigue.

What is realized presently, therefore, is only stepwise starting-up of the whole plant, inclusive of load retention points, by way of a temperature-controlled gas turbine start-up procedure up to attainment of the maximum exhaust-gas temperature, inclusive of the power retention points, for heating the components arranged downstream (heat recovery steam generator, steam turbine).

### SUMMARY OF INVENTION

It is an object of the invention to specify a method for starting up and shutting down a gas turbine in a combined cycle power plant in which, with emission specifications being complied with and the least possible fatigue of components arranged downstream of the gas turbine, the plant can be started up and shut down as quickly as possible.

The invention achieves the object, directed at a method for starting up and shutting down a gas turbine in a combined cycle power plant, in that it provides that, for such a method, the gas turbine comprises a compressor having adjustable guide vanes, and the gas turbine power is also controllable by opening of the guide vanes, wherein, during start-up, the gas turbine is run up to base load or up to an emission-compliant load point, wherein, prior to attainment of the base load or of the emission-compliant load point, the guide vanes are opened.

Due to the at least partial opening of the guide vanes, the mass flow through the gas turbine is increased at an early stage and the temperature of the exhaust-gas flow to downstream components is reduced. Complete opening of the guide vanes is typically avoided, for the purpose of avoiding excessively high emissions, at the relatively early period of the start-up procedure.

Here, it is expedient if the gas turbine is run up with a maximum possible load ramp. In this way, a quickest possible start-up is ensured.

It is advantageous if the guide vanes are closed at the beginning of the start-up procedure and, during startup, are opened as much as possible in compliance with emission specifications, since a larger mass flow leads to greater power and lower temperature of the exhaust-gas flow. It is essentially the operation of the plant “below” the design level that, as a result of the then worse emission values, limits the degree of the opening.

It is advantageous if the combined cycle power plant comprises an exhaust-gas chimney, and emissions are measured continuously in the exhaust-gas chimney.

It is furthermore advantageous if temperature sensors are read continuously during start-up and shutdown. It is in particular advantageous if the temperature sensors are read continuously on thick-walled components, that is to say on components with a ratio of outer diameter to inner diameter of greater than 1.2.

By way of the method according to the invention, the gas turbine, without any further gas turbine retention point, is run with the maximum possible load ramp up to base load or up to the emission-compliant load point (for example 70% gas turbine load) in a manner compatible in terms of temperature for the downstream components. Furthermore, the guide-vane adjustment mode of operation of the method according to the invention can also be used during a shutdown procedure, in order, in consideration of the boiler service life, to modify the gas turbine exhaust-gas temperature.

The following advantages are obtained: reduction of the stress loading on the heat recovery steam generator and minimum service life consumption of the heat recovery steam generator, reduction of the start-up emissions (NOx), improved and flexible operation over the entire load range, quicker start-up of the combined cycle power plant, including reduced fuel consumption, increased and quicker provision of power through the use of higher gas turbine load ramps during the start-up operation.

### BRIEF DESCRIPTION OF THE DRAWINGS

The invention will be discussed in more detail by way of example on the basis of the drawings, in which schematically and not to scale:

FIG. 1 shows a schematic illustration of a combined cycle power plant, and

FIG. 2 shows a graph of the electrical power of the combined cycle power plant against the exhaust-gas temperature.

### DETAILED DESCRIPTION OF INVENTION

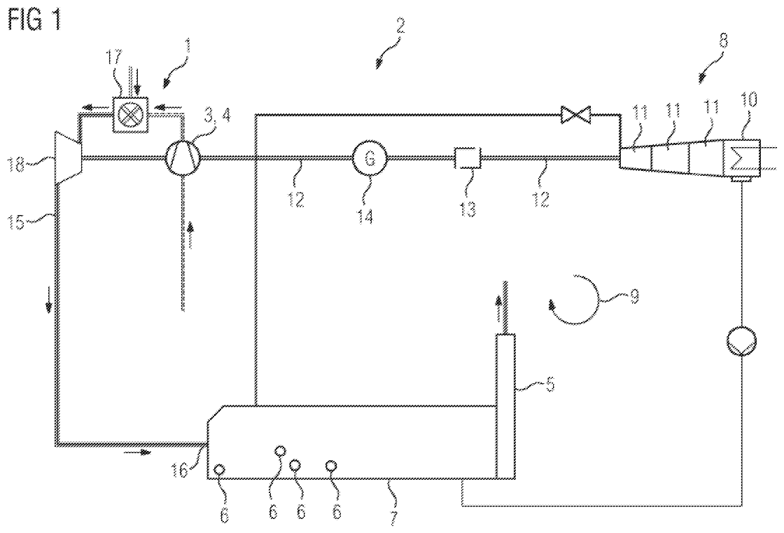

The schematic illustration in FIG. 1 shows a combined cycle power plant 2 with a gas turbine 1, with a heat recovery steam generator 7 and with a steam turbine 8. Other embodiments, such as for example two or more gas turbines with in each case one heat recovery steam generator arranged downstream or even with a common heat recovery steam generator, are also possible.

The gas turbine 1 comprises a compressor 3, a combustion chamber 17 and a turbine 18. The compressor 3 comprises adjustable guide vanes 4, by way of which the compressor air mass flow can be set.

A condenser 10 is arranged downstream of the steam turbine 8 in a water-steam circuit 9. The water-steam circuit 9 furthermore comprises the heat recovery steam generator 7, in which there are arranged, in particular on thick-walled components, temperature sensors 6.

The steam turbine 8 normally comprises multiple pressure stages 11, which drive the generator 14 via a common shaft 12 with a coupling 13.

For the purpose of feeding working medium or flue gas, expanded in the gas turbine 1, into the heat recovery steam generator 7, an exhaust-gas line 15 is connected to an inlet 16 of the heat recovery steam generator 7. The expanded working medium from the gas turbine 1, that is to say the gas turbine waste gas, exits the heat recovery steam generator 7 via an exhaust-gas chimney 5.

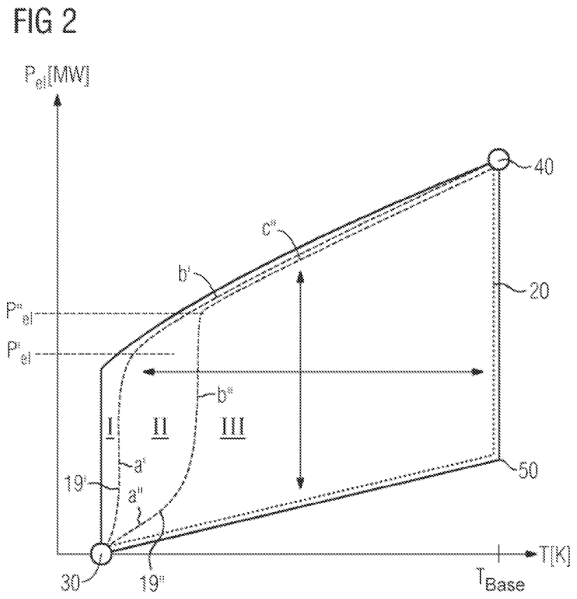

FIG. 2 shows the electrical power Pₑₗ in megawatts (MW) of the combined cycle power plant 2 plotted against the exhaust-gas temperature T [K] for the mode of operation 19′, 19″ according to the invention (two possible modes of operation, indicated by dashed lines) in comparison with the prior-art mode of operation 20 (indicated by dotted line).

In the case of the prior-art mode of operation 20, the guide vanes 4 remained closed until the gas turbine 1 was run up to a load 50 or to an emission-compliant load point. This guaranteed stable and emission-compliant combustion and, owing to the “low” exhaust-gas temperatures in comparison with modern gas turbines 1, was the preferred method.

With the method according to the invention, the mass flow through the gas turbine 1 is already increased prior to attainment of the load 50 or of an emission-compliant load point, as a result of which, inter alia, the temperature of the exhaust-gas flow is reduced.

The adjustable guide vanes 4 have a closure position, that is to say a minimum possible opening angle, which can be increased by adjustment in order to increase the compressor air mass flow. With start-up or shutdown, the guide vanes 4 preferably continue to be kept closed.

However, at any rate, the opening angle of the guide vanes is increased at a fairly early stage, in particular directly during start-up or shutdown.

In FIG. 2, it is shown for the mode of operation 19′ that the guide vanes 4 are opened as quickly as possible, so that, for the mode of operation 19′, the closed line 22 is reached as quickly as possible.

The curves for the modes of operation 19′, 19″ rise very steeply at the start (a′) or in the middle section (b″), such that barely any or a minimal change in the exhaust-gas temperature T occurs.

In a slightly altered start-up or shutdown method according to curve 19″, the opening angle of the guide vanes 4 is not kept constant from the start, but rather is opened more and more, in particular continuously, very particularly constantly and continuously, but not completely, over a specific period of time of the stage e and is then, according to stage b, run up to P″ with a minimum possible change in the exhaust-gas temperature T [K].

The procedures according to modes of operation 19′ and 19″ result in powers P′≈50% (19′) and P″≈60% (19″), respectively, of a base load 40 being attained as quickly as possible.

This can also be seen in the diagram in FIG. 2 in that the area II, I between the mode of operation 19′, 19″ and the upper boundary lines 22 of the solid line is minimized as much as possible and corresponds to significantly less than half of the area bordered by the prior-art mode of operation 20.

Preferably, a minimum possible opening angle is used at the starting point 30.

A period of time indicated by t_{BASE} means the period of time over which the gas turbine is run up to the base load 40 from the start time 30, and the maximum possible load ramp a′, b″ is preferably realized during the first third of the period of time indicated by t_{BASE}.

A temperature range indicated by T_{BASE} characterizes the temperature range up to the temperature T for the base load 40 from the start time 30, wherein a runup with the maximum possible load ramp a′, b″ is preferably realized within the first third of the temperature range indicated by T_{BASE}.

1. A method for starting up and shutting down a gas turbine in a combined cycle power plant, wherein the gas turbine comprises a compressor having adjustable guide vanes, and the gas turbine power is also controllable by opening of the guide vanes, the method comprising:
during start-up, running the gas turbine up to base load or up to an emission-compliant load point,
prior to attainment of the base load or prior to attainment of the emission-compliant load point, opening the guide vanes in such a way that barely any or a minimum possible change in the exhaust-gas temperature occurs.

2. The method as claimed in claim 1,
wherein the gas turbine is run up with a maximum possible load ramp.

3. The method as claimed in claim 1,
wherein a smallest opening angle of the guide vanes is used at the start time.

4. The method as claimed in claim 1,
wherein approximately 47% to 53% of the power is attained as quickly as possible during the runup.

5. The method as claimed in claim 1,
wherein, after a first stage, in a second stage, approximately 57% to 63% of the power is attained as quickly as possible during the runup.

6. The method as claimed in claim 1,
wherein, in a mode of operation, the guide vanes are opened in two different stages,
wherein, in a first stage, the guide vanes are opened slightly, and
wherein, in a second stage, the guide vanes are opened to a maximum extent so as to attain a maximum load ramp, for which barely any change in the exhaust-gas temperature occurs.

7. The method as claimed in claim 1,
wherein the guide vanes are closed at the beginning of the start-up procedure.

8. The method as claimed in claim 1,
wherein the guide vanes are opened as much as possible in compliance with emission specifications.

9. The method as claimed in claim 1,
wherein the combined cycle power plant comprises an exhaust-gas chimney, and emissions are measured continuously in the exhaust-gas chimney.

10. The method as claimed in claim 1,
wherein temperature sensors are read continuously during start-up and shutdown.

11. The method as claimed in claim 10,
wherein the temperature sensors are read continuously on thick-walled components, comprising components with a ratio of outer diameter to inner diameter of greater than 1.2.

12. The method as claimed in claim 1,
wherein the opening angle of the guide vanes is at least intermittently opened continuously.

13. The method as claimed in claim 1,
wherein a period of time indicated by t_{BASE} means the period of time over which the gas turbine is run up to the base load from the start time, and the maximum possible load ramp is realized during the first third of the period of time indicated by t_{BASE}.

14. The method as claimed in claim 1,
wherein T_{BASE} characterizes the temperature range up to the temperature for the base load from the start time, wherein a runup with the maximum possible load ramp is realized within the first third of the temperature range indicated by T_{BASE}.

15. The method as claimed in claim 6,
wherein, in the first stage, the guide vanes are opened continuously and constantly.

16. The method as claimed in claim 12,
wherein the opening angle of the guide vanes is opened continuously and constantly.
